(19) United States
(12) Patent Application Publication
(10) Pub. No.: US 2008/0130700 A1
(43) Pub. Date: Jun. 5, 2008

(54) Apparatus for generating laser radiation

(76) Inventors: Patrick Linder, Mandach (CH); Adrian Haldimann, Jegenstorf (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/741,850

(22) Filed: Apr. 30, 2007

(30) Foreign Application Priority Data
Apr. 29, 2006 (EP) 06 008 989.3

(51) Int. Cl. H01S 3/0933

(52) U.S. Cl. 372/55; 372/70

(57) ABSTRACT

A laser arrangement exhibits a laser rod or a laser tube (3) as well as a high-voltage connection (19) for generating the laser beam. This laser arrangement has, in addition to the high-voltage connection, at least one electromagnetic radiation source (25) in the region of the laser rod or laser tube, which is provided for initiating the laser. The laser exhibits the special function that it can be initiated by means of additional radiation source. Essential features are: initiation by action of external electromagnetic radiation source, for example light, x-rays, microwaves or other electromagnetic waves. What is more, the laser exhibits the special feature that in the case of a so-called mixed-light, white-light or mixed-frequency laser or maser, what is emitted in the emission of the laser or also maser is not the full spectrum but only the radiation excited by the additional radiation source. Thus it is now possible, without external mechanisms or special optics, to emit and to change only a quite definite wavelength.

### TECHNICAL FIELD

This invention relates to an arrangement for generating electromagnetic radiation, such as in particular a laser arrangement having a high-voltage connection, a method for initiating and operating an electromagnetic radiation and for operating a laser arrangement, and uses and applications of the arrangements of the method.

### BACKGROUND AND SUMMARY

The excitation of an electromagnetic radiation, such as for example of a laser, or the generation of a laser beam in a laser tube can be effected for example with high voltage, in particular in the operation of a so-called gas laser. Here a voltage adequate to generate the laser effect or laser beam is imposed, the strength of the voltage being dependent on, among many other things, the length of the tube, the pressure, under some circumstances the gases used, etc.

As a rule, gases or gas mixtures that are suitable for generating certain electromagnetic waves or colors or color mixtures are employed in gas lasers, such as for example helium-neon mixture, argon, argon-CO₂ mixture, CO₂, krypton mixture, etc.

Through the use of various gas mixtures it is possible to generate so-called chromatic lasers or even white-light lasers. Here it is disadvantageous, however, that undesired color contributions must be filtered out with additional optical arrangements such as for example prisms, color filters, etc. This, however, leads to a loss of the effective power relative to the power expended.

It is therefore an object of the invention to propose a practice that makes possible color filtering, or the generation of a laser beam having a precisely defined wavelength, without the necessity of an additional filter arrangement.

According to the invention there is proposed an arrangement for initiating and operating an electromagnetic radiation, such as in particular a laser arrangement, having a high-voltage connection for generating the electromagnetic radiation, wherein in addition to the high-voltage connection there is at least one further electromagnetic source for initiating the radiation.

The laser arrangement proposed according to the invention exhibits the customarily used laser rod or a laser tube, as well as a high-voltage connection for the operation of the laser beam, at least one electromagnetic radiation source, such as for example a light source, being provided in the region along the laser rod or laser tube in order to initiate the laser, in addition to the possibility of operation with high voltage.

According to one embodiment, the electromagnetic radiation source is a diode arrangement, a plurality of diodes, for example, being arranged preferably in a line along the laser rod or laser tube. Here the diode arrangement used is one having a radiant power that is sufficient, when supplementing the imposed voltage, to initiate the laser.

The diode arrangement exhibits a certain emission of electromagnetic waves, or the light emitted by the diodes exhibits a certain wavelength, that corresponds to the wavelength or color that is to be selected from the wavelength or colors excitable in the laser tube or laser rod. The electromagnetic radiation generated can only be such a radiation as can also be generated in the medium (laser tube/laser rod, etc.) by virtue of its physical properties.

The diodes of the diode arrangement are preferably operated in pulsed fashion.

Again, according to a further embodiment, it is possible to arrange a plurality of diode arrangements along the laser rod or laser tube, the individual diode arrangements emitting different wavelengths of light. Infrared rays, x-rays, microwaves, etc., or a combination of the various radiation sources can be used, among others, as electromagnetic radiation sources.

Further preferred embodiments of the laser arrangement are disclosed hereinafter.

There is further proposed a method for initiating and operating an electromagnetic radiation or for electromagnetically initiating a light source, wherein a high voltage is initially imposed with a power that is insufficient or barely sufficient to initiate the radiation of the light source, and wherein the initiation proper of the electromagnetic radiation of the light source is effected by means of an additional electromagnetic radiation source.

What is proposed according to the invention is first to utilize a high-voltage connection to impose a voltage that lies just below the initiating voltage or makes possible only an unstable initiation of the radiation source or light source and subsequently makes it possible to initiate and operate the radiation source or light source by means of an additional radiation source. The advantage of this procedure for initiating and operating an electromagnetic radiation or light source, as in particular a laser, is that there is no necessity of imposing initially a needlessly high high voltage, which causes great stress to the radiation arrangement, needlessly generates heat and is very energy-intensive. Besides, initiation by means of the additional radiation source makes it possible, after initiation, to optimize the necessary voltage by which the radiation arrangement or laser is to be operated.

What is proposed specifically is a method for generating a laser beam having a desired wavelength by imposing on a laser operated with high voltage only a portion of the voltage necessary to initiate the laser and initiating the laser with an additional electromagnetic radiation source such as a light source.

Both the laser arrangement according to the invention and the method are possible per se for any kind of laser, maser, etc., but gas lasers with mixed gases are the preferred topic of discussion.

Possible areas of application are for example image projection, light shows, the generation of certain laser effects, the use for illumination purposes or the use of special lasers in research. Further, it is possible to conceive of medical lasers having high power, low energy consumption, as well as small footprint and various precisely tuned wavelengths.

The laser principle described according to the invention has the following great advantage over conventional gas lasers:

Because of the wavelength-oriented excitation by, for example, an additional light source, the laser emits only the desired wavelengths and its modes, which is generally not possible with gas-filled mixed-light or white-light lasers. Thus with an argon laser, for example, the undesired contribution must be filtered out with prisms, color filters or coated mirrors, which represents a loss of effective power in operation relative to the power expended. This further results in severe heating as well as higher laser power consumption.

A further advantage of the invention or of the preferred kind of gas laser pumping as described consists in the possibility of much faster modulation, which, for example at 4.31818 MHz modulation, makes possible an image resolution of 640×400 points, which results for example in an image sequence of 25 frames. Under corresponding conditions, only 256 colors could be reproduced in the prior art. Of course these are not absolute limits, since with the fast LEDs now commonly available or with other faster semiconductors it is entirely possible to get better resolution and greater color depth. Still a further advantage due to the low power dissipation lies in the more compact construction and thus lower manufacturing cost.

The presumed principle is based on the idea that the following happens in the laser tube filled with gas mixture:

The imposition of a high voltage brings the atoms or molecules present in the gas mixture from a lower to a higher energy level. The high voltage is selected so that the electrons are shortly to drop back to a lower energy level. Here the voltage is known to depend on the temperature, tube length, pressure, and gas employed. Now, by means of the light sources placed around the inner tube (the use of LEDs is proposed according to the invention, for example, as depicted in FIG. 1), electromagnetic radiation, such as for example photons, is radiated into the already excited gas mixture. The incident electromagnetic radiation in the form of photons of one or a plurality of well-defined wavelengths (of low power) ensure, in this kind of stimulated emission, that only the atoms (also for molecules and solid bodies) in the gas mixture that can be excited by the incident electromagnetic radiation make a transition from a higher to a lower energy level and, in doing so, emit a second photon that exhibits the same optical properties (phase, wavelength) as the incident photon (emitted by LED). The other atoms (representative also for molecules and solid bodies) that are not excited remain at the higher energy level and absorb no further energy, that is, the current consumption becomes smaller because further operation requires the expenditure of only so much energy as to bring the atoms that have dropped to the lower energy level back to a higher energy level (higher efficiency). The result is an amplification process, which is used for light generation in the laser tube. In other words, between the 100% mirror and the output coupler there is a stimulated oscillation, which is coupled out through the exit mirror as a laser beam of one or a plurality of certain wavelength(s)/phase(s). In this way, the stimulated emission desired according to the invention takes place only at that or those wavelength(s) that is or are excited by the external electromagnetic radiation source(s).

In general, light is attenuated by absorption rather than amplified upon passage through a medium. The reason is that at thermal equilibrium a larger number of atoms are in the low energy state, so that absorption dominates over emission. An essential condition for laser amplification is population inversion, that is, a condition in which more atoms are at a higher energy level than at the lower one. Such an inversion is effected by the supply of optical (electromagnetic) power (as in the helium-neon laser).

This means, first, that if a high voltage just up to the level at which electrons drop back from the higher to a lower energy level is imposed (high voltage on the glass tube anode/cathode), then in order to trigger the dropping back, photons of one or a variety of wavelengths are introduced into the inner laser tube via one or a plurality of initiating source(s) (LED, etc.), and in this way dropping back with the emission of a photon is commenced, which in turn triggers an avalanche effect in the gas mixture and commences the stimulated optical oscillation and then leads to amplified electromagnetic radiation emission through the output coupler (laser beam). A 720 nm LED triggers only photons of the same wavelength.

By way of clarification it is noted here that even if a laser (a He—Ne laser) must be initiated just once and afterward is “self”-excited, and only an operating voltage is still present. An example is a He—Ne laser tube manufactured by Meles Griot, which requires an initiating voltage of, say, 1.6 EV¹ and afterward falls back to an operating voltage of 200 V. Translator's Note: Thus in the original; error for kV?

When a gas laser is used, argon-CO₂ or other mixed-gas lasers can be used for example as white-light lasers or so-called mixed-light or chromatic lasers. This means that most of the visible wavelengths can arise or be excited therein, the wavelength of the light source necessarily, of course, coinciding with one of the wavelengths to be excited in the laser arrangement.

### BRIEF DESCRIPTION OF DRAWINGS

The invention is now explained in greater detail by way of example and with reference to the appended Drawings, in which:

FIG. 1 depicts schematically, in longitudinal section, a laser arrangement according to the invention for generating a laser beam of a desired wavelength;

FIG. 2 depicts schematically, in longitudinal section, a specific embodiment of a laser arrangement according to the invention;

FIG. 3 is a cross section through the laser arrangement of FIG. 2 along the line K-K;

FIG. 4 depicts an end cap of the laser arrangement of FIG. 2, viewed in the direction of arrow A;

FIG. 5 depicts an end cap of the laser arrangement of FIG. 2, viewed in the direction of arrow B;

FIG. 6 depicts a further embodiment of a laser arrangement according to the invention;

FIG. 7 depicts schematically, in cross section, an end cap of the laser arrangement analogous to that in FIG. 4 having an adjusting apparatus for adjusting the output coupler;

FIG. 8, analogously to FIG. 7, depicts an end cap according to FIG. 4 but with electronic mirror positioning;

FIG. 9 again depicts a further embodiment of a laser arrangement according to the invention having an initiating source that is situated outside the laser tube using a lead that conveys electromagnetic radiation; and

FIG. 10 depicts, in longitudinal section, a laser arrangement additionally exhibiting a device for charging the laser tube with various gases or gas mixtures.

### DETAILED DESCRIPTION

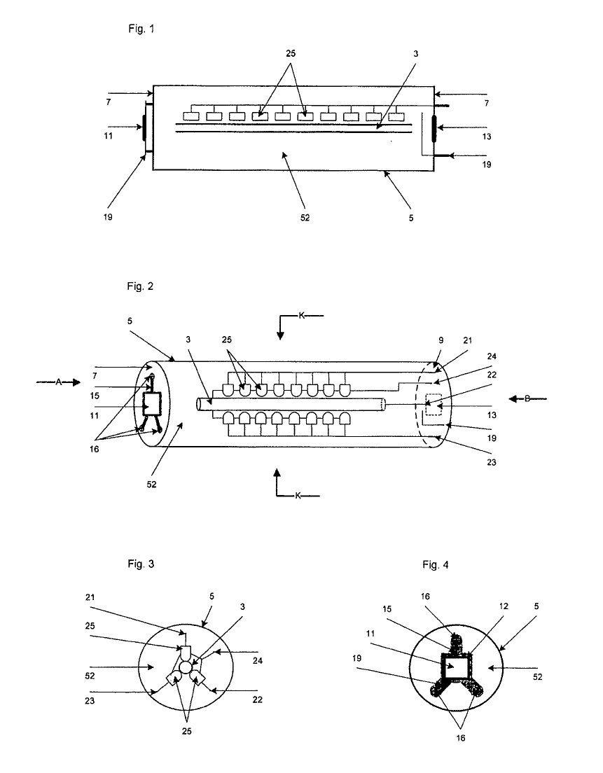

In the laser arrangement schematically illustrated in FIG. 1, laser tube 3 is arranged in an outer tube 5, made for example of quartz glass, in which laser tube proper there is arranged the gas or a certain gas mixture such as for example helium-neon gas, krypton gas, an argon-CO₂ mixture, etc. A high-voltage connection 19 is provided for initiating or operating the gas laser. Supported in front of each respective end cap 7 are two mirrors 11 and 13 serving as resonator for generating the laser beam.

According to the invention it is now proposed to arrange additional light sources along inner laser tube 3, such as for example LEDs 25, by means of which the laser beam proper is initiated.

The laser proposed according to the invention is operated in the following manner:

First, a determination is made of the high voltage at which the laser beam is initiated. Now the voltage is reduced to, for example, a value just below the initiating voltage, so that the laser is not initiated. In order to initiate the laser, light sources such as LEDs 25 are used, these having a power such that initiation of the laser is enabled.

Precisely the wavelength that is to be selected from the mixed light of the laser is excited in the laser tube by the wavelength emitted by the LEDs. Because of the laser arrangement, which, governed by the spacing of both mirrors 11 and 13 and the gas mixture used, permits only a limited number of wavelengths, the wavelength of the light source must naturally correspond to one of these selected wavelengths. If for example the spacing between the mirrors is 1 meter, then the wavelength of the light-emitting diodes must exhibit a value of, for example, 100 nm, 200 nm, etc., as well as ½ or any wavelength divisible into this meter, since otherwise no excitation at all is possible.

FIG. 2 depicts schematically, in longitudinal section, a specific embodiment of a laser arrangement 1 according to the invention. Once again, a laser tube 3, in which the desired gas or the desired gas mixture is present, is arranged in an external tube, such as for example glass tube 5, which is hermetically sealed at both ends by caps 7 and 9. The inner tube should not be hermetically closed off from the outer tube, so that the gas can circulate between the inner tube (the laser tube proper) and the outer tube.

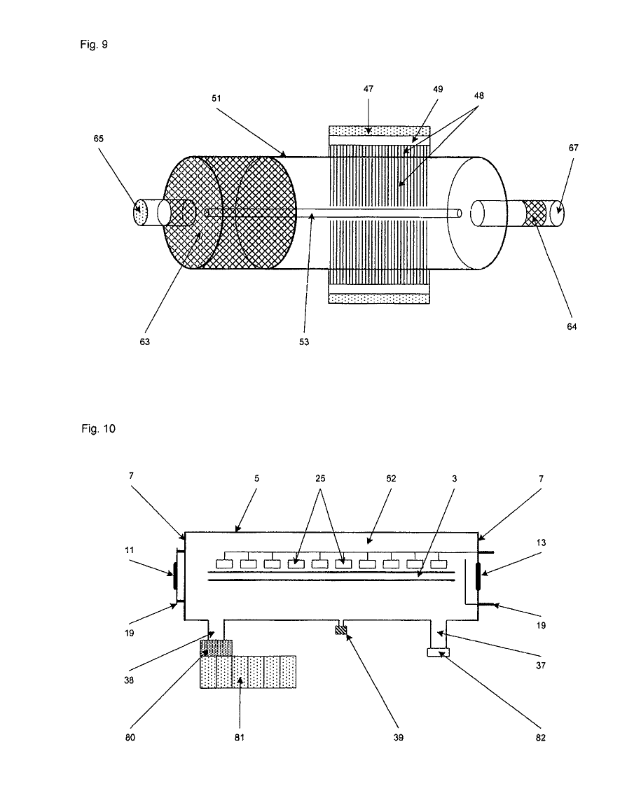

Arranged in front of each of respective caps 7 and 9 are two reflecting mirrors 11 and 13, which must be arranged at a precisely specified spacing and plane-parallel to each other. For the adjustment of the spacing and plane-parallelism, mirror 11 on cap 7 is arranged with a special holder 15, which is additionally illustrated in enlarged view and in detail in FIG. 4. By screw connections 16 by means of which the holder is attached to cap 7. The precise adjustment of the mirror is described in greater detail with reference to FIGS. 7 and 8.

Further, on cap 9 there is a connection 19 for the imposition of the high voltage, the connection at the opposite end of tube 5 being effectable via arms of holder 15, which are fabricated for example from a highly conductive material. Additional metallic framing 12 around mirror 11 makes it possible to generate a uniform high-voltage field.

Arranged in the interior of tube 5, which is manufactured for example from a quartz glass, are LEDs 25, which are rigidly arranged on corresponding boards. LEDs 25 are so oriented relative to inner laser tube 3 as to enable an optimal illumination or excitation of the gas or mixture.

The position of light-emitting diodes 25 is better illustrated with reference to FIG. 3, which depicts a cross section through tube 5 along line K-K. Connections 21 and 23, protruding laterally from cap 9, are provided for powering the LEDs.

In an arrangement illustrated in FIG. 2, it is now possible to use distinct light sources or LEDs for initiating a laser in one and the same laser arrangement, the LEDs emitting distinct colors. Thus the three LED arrangements, which can be seen clearly in FIG. 3, can excite red, green and also blue light, the excitation of a mixed color also being possible if they are operated simultaneously. Through the use of further LED arrangements it is further possible to generate electromagnetic radiation, such as for example also in the ultraviolet or infrared spectrum.

Because only one wavelength need be excited in the laser tube in order to generate a certain monochromatic color beam, the laser arrangement according to the invention can be operated at a lower power, which naturally also leads to less evolution of heat. Thus cooling such as is used when operating conventional lasers may become unnecessary, or only minimal cooling of lower power and smaller size may be necessary, as appropriate.

As has already been noted, FIG. 4 additionally and in detail illustrates cap 7 of the laser arrangement of FIG. 2 as viewed in the direction of arrow A. Holder 15 and screw connections 16, by which the holder is attached to cap 7, make possible a precise adjustment of mirror 11. In the direction of arrow B in FIG. 2, FIG. 5 depicts the opposite cover or rear end cap 9 which contains 100% reflecting mirror 13. Arranged in this rear cap are the several LED connections 21, 22 and 23 as well as LED ground connection 24. Finally, high-voltage connection 19 can be seen.

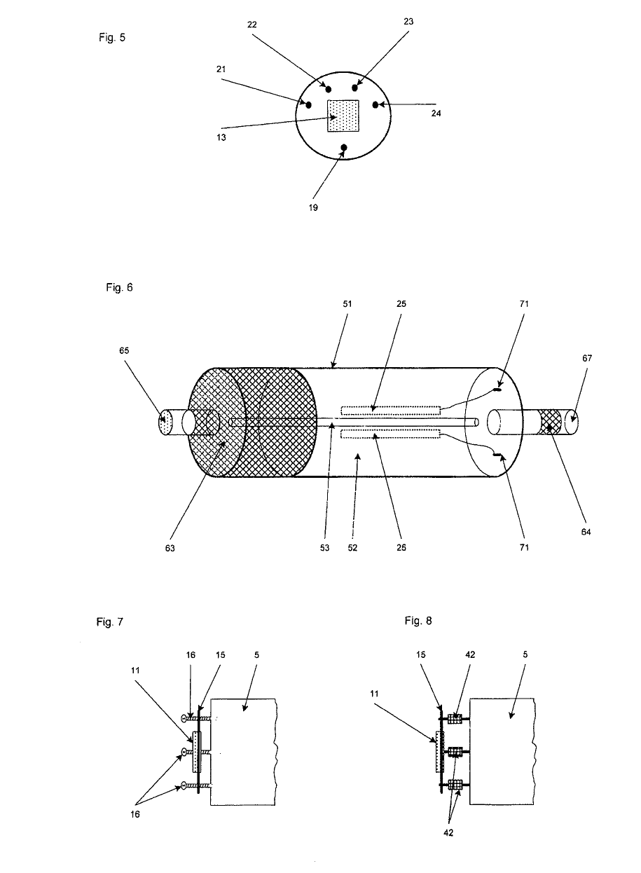

FIG. 6 depicts a further embodiment of a laser arrangement according to the invention, wherein once again a gas laser tube 53 is arranged in the interior of an outer glass tube 51. Again, mirrors 65 and 67 are provided laterally in front of the respective caps. So that the high voltage can be imposed, a connection 71 is provided at one end to connect metal cathode 63, which is arranged in sleeve fashion, and at the other end a metal anode 64. Instead of the multiplicity of individual LEDs provided in FIG. 2, now it is proposed according to FIG. 5 to arrange so-called LED bars along the inner laser tube, which yields for example a substantially higher efficiency in initiating the laser beam. Once again, laser tube 53 is filled with a gas such as for example with an argon-CO₂ gas mixture, helium-neon gas, etc.

As already noted, the precise adjustment of the output coupler arranged in cap 7 is to be explained in greater detail with reference to FIGS. 7 and 8. Output coupler 11 is arranged on a holder 15, which in turn is connected to tube 5 by screw connections 16, as illustrated in FIG. 7. As can be clearly seen in the sectional view of FIG. 7, it is now possible by manual means to adjust mirror 11 with screw connections 16 or to align it precisely to reflecting mirror 13 arranged at the rear.

In FIG. 8, again illustrating a section through front cap 7, screw connections 16 are replaced by electronic mirror positioners 42 such as for example piezoelements, electric motor elements, etc. The adjustment can be done automatically as appropriate to the arrangement as illustrated in FIG. 8.

Similarly to the embodiment of FIG. 6, FIG. 9 depicts a further laser arrangement according to the invention, wherein, however, the excitation is now effected by the electromagnetic radiation from outside the glass tube. The radiation generated by a radiation source 47, such as for example an initiating light source, is first led through a color filter or frequency doubler, the frequency doubler being for example neodymium, yttrium-aluminum garnet crystals or others having this effect. In other words, the radiation emitted by the radiation source, having for example 1064 nanometers (infrared), is doubled for example by crystal layer 49, so that a radiation of 532 nanometers results. Following the frequency doubler, the radiation, such as for example the electromagnetic initiating radiation source, is led by radiation waveguide 48 to gas laser tube 53, the “optical waveguides” 48 having a high thermal stability. The great advantage of this arrangement is that, on the one hand, frequency doubling makes it possible to generate radiation for which there is normally no corresponding light source. Furthermore, the heat due to the radiation is primarily generated outside glass tube 51, so that cooling on glass laser tube 53 becomes unnecessary or at least needs to have only a low power.

The remaining components of the laser arrangement of FIG. 9 correspond to those of the arrangement of FIG. 6; that is, both mirrors 65 and 67 are arranged at either end of glass laser tube 53, as well as metal cathode 63 in sleeve-like arrangement and metal anode 64 at the opposite end to generate the high voltage.

A mercury vapor lamp or a white-light source or other suitable radiation source can for example be employed as light source 47. Instead of frequency doubling, of course, a frequency filter can be arranged in order to filter out one or a plurality of wavelengths specifically.

In FIG. 10, finally, a further embodiment of a laser arrangement according to the invention is again illustrated in longitudinal section, the basic principle of the laser corresponding to what was described with reference to FIG. 1. The essential feature of the laser arrangement of FIG. 10 is that operation in one and the same laser arrangement is possible with various gases or gas mixtures. To this end, at least two connection openings 37 and 38 are provided on outer tube 5, these being on the one hand a charging fitting 38 as well as a valve fitting 37.

One or a plurality of sensor(s) 39 is/are provided on the tube for acquiring or determining the gas mixture present in the tube, the pressure, etc. Connected ahead of charging fitting 38 is a mixing battery 80 for mixing various gases, which are stored in various gas tanks 81. Finally, an outlet valve or pressure relief valve 82 is provided on valve fitting 37.

According to the laser arrangement as illustrated in FIG. 10, it is now possible to generate a laser with a certain gas mixture and to break off operation after a certain time. Now glass tube 5 & 3 is “purged” and then charged with a different gas or a different gas mixture. Next, the laser is re-initiated, then possibly being for example a laser in a different color or even a chromatic laser.

The laser arrangements described with refrence to FIGS. 1 to 10 are of course merely examples, which can be changed, modified or supplemented with further elements in wholly arbitrary fashion. In particular, the description of laser arrangements according to the invention made no reference to any size calculations, since these are not essential to the invention per se. Thus for example it is possible to use laser tubes according to the invention having a length of 20 cm, 1 m, 2 m, etc. The number of light sources used, as in particular of LEDs, is also immaterial per se. Thus for example it is possible to use seven LEDs along a laser tube 20 cm long or to use 20 or more LEDs along a 1 m laser tube, or under some circumstances it is even better to use a so-called LED array (LED bar). It is also entirely possible to use a solid-state laser or a liquid laser instead of a gas laser, a specific light source ultimately being used that exhibits the wavelength to be generated by the laser.

An interesting use of the laser arrangement as proposed in the invention is image projection with a laser projector. In laser arrangements customarily used for image projection at present, at least three laser-beam generators are used in each case, namely to generate a red light laser, a green light laser and a blue light laser (RGB=red, green, blue). The beams are subsequently merged and the laser beam so generated is deflected, for example by a polygon scanner, so that horizontal lines are written. When a line has been written, a second mirror deflects the beam one line downward. This can also be implemented with just one mirror (polygon) that is movable in both axes. In this way the whole image is written at length. The principle is fully correspondent to the cathode-ray tube, as it is known from a television receiver. According to the invention, one single laser-beam arrangement as proposed by the invention can be employed instead of the abovementioned three laser-beam generators, which makes possible a considerable simplification and, in association therewith, a reduction in the cost of such an arrangement.

Further uses are for example the generation of certain laser effects, light shows, the use for illumination purposes, for research. Further embodiments are for example medical lasers having high power, low energy consumption, as well as small footprint and various precisely tuned wavelengths. Again, a further application is in so-called depilation devices, in which the desired wavelengths for the removal of hairs are first determined or measured with color filters, in order that the laser can be adjusted to the optimal wavelength or wavelengths. This kind of laser is also best suited to the removal of tattoos and the treatment of melanomas.

1. An arrangement for generating electromagnetic radiation, as in particular of a laser, having a high-voltage connection (19) for generating the electromagnetic radiation, wherein in addition to the high-voltage connection there is at least one further electromagnetic radiation source (25) for initiating the radiation.

2. A laser arrangement exhibiting a laser rod or a laser tube (3) as well as a high-voltage connection (19) for generating the laser beam, wherein in addition to the high-voltage connection at least the further electromagnetic radiation source (25) is provided in the region of the laser rod or laser tube for initiating the laser.

3. The laser arrangement of claim 2, wherein the further electromagnetic radiation source is at least one kind as laser initiator selected from the group consisting of microwave radiation, infrared radiation, ultraviolet light, and x-rays.

4. The laser arrangement of claim 2, wherein the further electromagnetic radiation source is an arrangement of light-emitting diodes (25).

5. The laser arrangement of claim 2, wherein the further electromagnetic radiation source is an arrangement of light-emitting diodes (25) operated in pulsed fashion having a power sufficient, when supplementing the imposed high voltage, to initiate the laser.

6. The laser arrangement of claim 2, wherein there are a plurality of further electromagnetic radiation sources having distinct wavelengths or electromagnetic emissions in order to generate a multiple or sequential driving in the laser rod or laser tube when, as appropriate, at least two of the additional radiation sources are operated in simultaneous or sequential, pulsed, fashion.

7. The laser arrangement of claim 2, wherein the further electromagnetic radiation source is a diode arrangement (25) having a certain light frequency emission or wherein the diode arrangement emits a certain wavelength of light, and wherein a reflector is arranged around the diode arrangement in order to concentrate as nearly as possible all of the electromagnetic radiation into the laser rod or laser tube.

8. The laser arrangement of claim 2, wherein the further electromagnetic radiation source includes a plurality of diode arrangements having distinct wavelengths or color emissions in order to generate a mixed color in the laser beam when, as appropriate, at least two of the diode arrangements are operated in simultaneous, pulsed, fashion.

9. (canceled)

10. The laser arrangement of claim 2, wherein the further electromagnetic radiation source includes a plurality of diodes or diode arrangements arranged in a line along the laser rod or laser tube, and equally spaced over the outer circumference of the rod or tube relative to the cross section.

11. (canceled)

12. The laser arrangement of claim 2, including two mirrors, wherein at least one of the mirrors is arranged at an end of the laser rod or laser tube in order to generate the laser beam and is adjustable or alignable relative to the other mirror by means of piezoactuators and electric drive motors , and wherein, a control is provided for automatically controlling or adjusting the mirrors

13. (canceled)

14. The laser arrangement of claim 2, wherein, after the radiation source, there is arranged at least one of a radiation filter and a frequency-doubling arrangement selected from the group consisting of a neodymium and a yttrium-aluminum garnet crystal, and wherein thermally stable optical waveguides are provided for transmitting the electromagnetic radiation to the laser tube or laserrod.

15. The laser arrangement of claim 2, further comprising at least one gas inlet device and one gas outlet, and a mixing device for gases at the gas inlet, in order to charge the laser with distinct gases or gas mixtures.

16. A method for initiating and operating an electromagnetic radiation of a light source, wherein a high voltage is initially imposed with a power that is insufficient or barely sufficient to initiate the radiation of the light source, and wherein the initiation proper of the electromagnetic radiation of the light source is effected by means of an additional electromagnetic radiation source.

17. The method of claim 16 for operating a laser, wherein the high voltage is imposed on the laser with a power less than 100% of the initiating voltage, and wherein the laser is initiated and, as appropriate, operated by means of the additional electromagnetic radiation source.

18. The method of claim 17, wherein the initiation is controlled electronically by first initiating the laser and then reducing or turning down the power to below the initiation point, and subsequently the laser is initiated and operated by means of the additional radiation source, at one or a plurality of desired electromagnetic radiation frequencies as appropriate.

19. The method of claim 17, wherein the additional radiation source is operated at a power that is at least or greater than the difference between the initiating voltage and the effectively imposed high voltage, in such fashion that the laser can be initiated by means of the radiation source.

20. The method of claim 17, wherein a diode arrangement operated in pulsed fashion is used as the additional electromagnetic radiation source.

21. The method of claim 17, wherein the additional electromagnetic radiation source includes at least one of a white-light source , an infrared source, an ultraviolet source and x-rays, the emitted waves from the source being led through at least one of a prism and a color filter or monochromator and filtered into the desired wavelength, and delivered to a laser tube or laser rod via optical waveguides in the form of glass fibers.

22. The method of claim 17, wherein, for generating a laser beam of desired wavelength, the high voltage is imposed on the laser operable by means of voltage, which high voltage partly corresponds to the initiating voltage necessary for initiating the laser, and wherein the laser is initiated by means of the additional radiation source, which emits light or radiation in the desired wavelength range.

23. The method of claim 17, wherein the wavelength of the radiation source is such that it corresponds to the desired wavelength of the laser light to be generated, the spacing between two mirrors of the laser that are responsible for generating the laser beam being such that the desired wavelength can be achieved.

24. The method of claim 17, wherein a gas mixture is variably adjustable in a laser tube of the laser, and wherein automatic control as well as one or a plurality of desired wavelengths can be realized through the cooperation of tunable radiation source for initiation, the correct gas mixture in the laser tube, and the adjustable mirrors for mode output coupling.

25. The method of claim 17, wherein the laser is a gas laser operating with a gas mixture selected from the group consisting of argon, CO₂ and helium-neon gas.

26. Use of the laser arrangement of claim 2, for one of image projection, light shows, for generating certain laser effects, for illumination purposes, and for research.

27. The method of claim 17, wherein the laser is a medical laser having high power, low energy consumption, as well as small footprint and various precisely tuned wavelengths.

28. The method of claim 17, wherein the laser is a depilation device for measuring the desired wavelength with color filters and thereupon adjusting the optimal wavelength of the laser according to the hair color in question to be removed by the device.
